(19) United States
(12) Patent Application Publication
(10) Pub. No.: US 2006/0218933 A1
(43) Pub. Date: Oct. 5, 2006

(54) Method for producing a model-based control device

(76) Inventors: Bruno Schuermans, Basel (CH); Christian Oliver Paschereit, Berlin (DE)

Correspondence Address: CERMAK & KENEALY LLP, 515 E. BRADDOCK RD, SUITE B, ALEXANDRIA, VA, 22314, US

(21) Appl. No.: 11/276,005

(22) Filed: Feb. 9, 2006

(30) Foreign Application Priority Data
Feb. 10, 2005 (DE) 10 2005 005 963.5

(51) Int. Cl. F02C 7/26

(52) U.S. Cl. 60/776

(57) ABSTRACT

Relating to a model-based active control system for a gas turbine, a method for obtaining the data that are used for deriving an active closed loop controller for the gas turbine includes splitting the combustion system into a number of submodels. The measurement of some submodels is achieved by system identification on a single burner test facility. Other submodels are then determined by using known acoustic models. The different submodels are subsequently combined to form an acoustic network model that is subsequently used to develop a closed loop controller.

This application claims priority under 35 U.S.C. §119 to German patent application number 10 2005 005 963.5, filed 10 Feb. 2005, the entirety of which is incorporated by reference herein.

### BACKGROUND OF THE INVENTION

1. Field of the Invention

The invention relates to a method for producing a control device for controlling pressure pulsations of a combustion process that is running in a combustion chamber, operated at high pressure, of a gas turbine operating with a number of burners, a closed loop controller of the control device operating with the aid of a control algorithm that is based on an overall mathematical model of the acoustic behavior of the combustion system.

2. Brief Description of the Related Art

Gas turbines are usually operated on the basis of the combustion of fossil fuels. Methods for burning fossil fuels are currently determined by two main requirements that stand in the way of one another. On the one hand, a combustion process should have the highest possible effectiveness in order in this way to save fuel and to reduce the CO₂ emissions. This can be achieved at particularly high process temperatures. On the other hand, the combustion process should be carried out such that the pollutant emissions, in particular emission of NOₓ, are minimized. However, there is a disproportionate increase in production of NOₓ with increasing process temperature.

Conventional gas turbine systems usually operate under the precondition of a lean premixed combustion, and require for this purpose combustion chambers of the annular, can, can-annular, or silo type. Such combustion systems are typically based on a spring-stabilized flame in which a small recirculation zone is formed at the outlet of the burners by aerodynamic means. This allows ignition and burnout in a very compact combustion zone, something which results in very short residence times (in the range of a few ms), and therefore permits the use of very compact combustion chambers.

Such a system is usually operated with a very lean flame (λ≧2) at approximately 20 bar, the oxidant, usually air, being preheated to approximately 720° K. by compression, the flame temperature being approximately 1750° K. Typical systems have an ignition delay time in the range from 3 ms to 5 ms, the residence times being in the range from 20 ms to 30 ms. Targeted emission limits are below 10 ppm for UHC and CO, and likewise below 10 ppm for NOₓ, normalized in each case at 15% O₂. These exemplary conditions relate to a gas turbine that is being operated in full-mode load, it being necessary at the same time for the abovenamed boundary conditions to be observed.

A disadvantage of such systems is the production of self-induced pressure pulsations. These are produced from the small recirculation zones that form at the outlet of the burner. These recirculation zones are not stable and can lead to pressure changes that are denoted as pulsations with reference to the combustion chamber.

This tendency to generate pressure fluctuations means that it is necessary for such a system to be operated with constrained operating conditions in order to minimize the pressure pulsations. Pressure pulsations can have dramatic effects on the mechanical strength of the combustion system. Consequently, pressure pulsations dependent on the combustion process have the effect of limiting the bandwidth of the operating conditions in which the combustion system can be operated with low emissions and high efficiency.

The control of acoustic vibrations, which lead to pulsations, is gaining more and more in importance as a consequence of these restraining actions of the pulsations on the operating conditions. In fact, the control of the acoustic vibrations is an essential criterion with the design, development, and maintenance of combustion systems.

The ways of controlling the pressure pulsations can be subdivided into two categories in essence, firstly into a passive means and secondly into active control. Passive means comprise a specific design of the combustion system in order to avoid instabilities or to absorb acoustic energy. Active control comprises the attempt to eliminate pulsations by using active measures.

Active control is based on the principle of permanently disturbing one or more flow variables in order to attempt to break up the pressure pulsations. In this sense, active control is relatively closely related to the principle of antisound, in which the actions of first sound waves are triggered by a superposition with second sound waves.

Active control with the aid of a closed loop, that is to say a closed loop controller, comprises the detection, with the aid of a sensor, of the pulsations that are produced by the combustion system. The sensor detects a signal that is correlated with the acoustic field of a gas turbine. A pressure transducer is normally used for this purpose. The signal of the sensor is fed back to an actuator via a closed loop controller. The actuator then varies one of the flow variables such as, for example, the flow of the combustion air or the fuel flow in such a way that the pulsations caused by the burner are thereby reduced. As an alternative, the actuator can also act on another important parameter influencing the combustion.

The closed loop controller uses the sensor signal in order to determine how the actuator is to influence the selected combustion parameter. The closed loop controller is equipped with a suitable control algorithm. Control algorithms can be subdivided into two groups: model-based closed loop controllers and adaptive or self adjusting closed loop controllers. Adaptive and self adjusting closed loop controllers require no model of the system.

In a model-based closed loop controller, the control algorithm is constructed on a mathematical model of the system. The mathematical model, which describes the thermoacoustic dynamics of the system, can be determined either from physical knowledge or from physical relations of the system, or with the aid of experimentation techniques. The determination of a mathematical model with the aid of an experimentation technique is frequently also denoted as system identification.

As soon as the relevant data for the mathematical model have been determined, it is possible to derive an active closed loop controller that is based on these data. Many conventional synthesis techniques can be used to this end.

However, the determination of the data for the mathematical model is not trivial. Gas turbines that have been operated exhibit surroundings hostile to measurements and are not necessarily suitable for carrying out measurements in the gas flow guided therein. Moreover, serious spatial constraints pertain to gas turbines, and so it is not possible to use sensor or actuator apparatuses of large design. Since the extent to which any technique based on a mathematical model can be used is a function of the quality of the data used in the model, it is of great importance that the data reproduce as accurately as possible the characteristics of the combustion system.

### SUMMARY OF THE INVENTION

It is here that the invention begins. One aspect of the present invention addresses the problem of specifying, for a method of the aforementioned type, an improved embodiment that permits the provision of a reliably operating control device, in particularly with a comparatively low outlay.

Another aspect of the present invention is based on the general idea of firstly subdividing the overall mathematical model to analytical submodels that can be calculated by means of physical relationships, and empirical submodels that can be determined by means of experimental measurements. The empirical submodels can subsequently be determined by virtue of the fact that the experimental measurements required to this end are carried out on a single burner ambient pressure test facility gas turbine. Furthermore, the analytical submodels are calculated taking into account the experimental measurements carried out in order to determine the empirical submodels. Finally, the empirical submodels are determined, and the calculated analytical submodels are networked with one another, specifically taking into account a computational transformation that provides the transition from the single burner ambient pressure test facility gas turbine to the multi burner high pressure gas turbine in the case of which the control device based on the overall model is intended to be used to control the pressure pulsations. It is possible by this mode of procedure to reduce or avoid problems that can arise in the identification of complex mathematical models: for example when it is not certain that the respective system or model behaves in an asymptotically stable fashion or not. Specifically, it is possible in particular to operate the individual submodels such that they operate asymptotically with sufficient reliability, something which greatly simplifies the identification of the empirical submodels.

The use of a single burner ambient pressure test facility gas turbine, that is to say a test facility with a test facility gas turbine, that has only a single test facility burner and whose test facility combustion chamber operates at ambient atmospheric pressure, reduces the outlay on apparatus for the identification of the empirical submodels. For example, the test facility can be equipped with a large number of loudspeakers, as a result of which it is possible for the purpose of system identification to introduce an excitation signal into the system with the aid of the loudspeakers, and to measure the response system with the aid of an array of microphones. It is very difficult and expensive to install an array of microphones in the case of an actual multi burner high pressure gas turbine. Moreover, it is virtually impossible to equip such a gas turbine with suitable loudspeakers. Firstly, there is simply no space for mounting loudspeakers, which are, in particular, water cooled, on a compact gas turbine. Secondly, for the purpose of application on the gas turbine, the loudspeakers would need to be substantially larger and more powerful than when applied on the test facility. The point is that the gas density in the high pressure gas turbine is approximately 10 to 30 times greater than in the test facility, and this is to be ascribed to the high pressure ratios of a true gas turbine. Consequently, the loudspeakers would need to be 10 to 30 times more powerful than those suitable for the test facility. Such large loudspeakers would be completely impractical and very cumbersome and would be impossible to mount because of the constricted conditions of space.

The division of the mathematical overall model into empirical and critical submodels enables the determination or the identification of the empirical submodels with the aid of the comparatively simple test facility. Transformation can then be used to transfer the networked, that is to say recombined, overall model to the conditions of an actual gas turbine, as a result of which the overall model thus obtained can be used for a control device of an actual gas turbine. For example, the closed loop controller of the control device can be derived by means of the networked submodels. It is possible here to make use of conventional methods and modes of procedure in order to determine a closed loop controller with the aid of a given mathematical model.

The empirical submodels can, for example, represent interactions of at least one burner and the combustion chamber, and/or can represent reactions of a control device for setting a fuel quantity fed to the burners, and/or can represent dynamic processes that run inside the test facility combustion chamber from a reference position up to the exit of the test facility burner in the counterflow direction, and/or can represent dynamic processes that run inside the test facility combustion chamber from a reference position up to the exit of the test facility combustion chamber in the flow direction. The propagation of pressure waves in the combustion chamber, for example, can be represented by an analytical submodel.

It can be provided in an advantageous embodiment of the method that when determining an empirical submodel, at least one other submodel is varied with regard to geometry and/or operating conditions, whereas at the same time the empirical submodel to be determined is not varied. Particularly advantageous in this case is a development in which the variations of the at least one other submodel are carried out such that the overall model is asymptotically stable and/or has relatively small or uncritical pulsation amplitudes. This mode of procedure substantially simplifies the precise identification of the empirical submodel that is respectively to be determined.

In order to determine or identify the empirical submodels, it is possible, for example, to presuppose that the individual submodels are respectively stable per se such that any instabilities that may occur are caused by the feedback loop of the control system. The submodels thus identified can be combined to form a feedback system, that is to say to form a network of the calculated and determined submodels. The network or the feedback system represents the overall system that is linearized in the region of its nominal operating point. Such a model certainly does not cover the nonlinear dynamic processes of the system, but a closed loop controller that can stabilize a linearized system can also necessarily stabilize a nonlinear system.

The identification or determination of an empirical submodel can comprise at least one of the following measures: at least one loudspeaker is used to introduce pressure pulses of a specific frequency at a reference position into the test facility combustion chamber downstream of the test facility burner. The pressure of an air supply of the test facility burner and/or a fuel feed of the test facility burner are modulated, that is to say the volume flow of the air that is fed or the fuel that is fed is varied. A reaction of the overall model is measured by means of a number of microphones arranged next to one another in the flow direction arranged between the reference position and the exit of the test facility burner. The Riemann constants f and g that are used during the determination of one other empirical submodel and/or during the calculation of an analytical submodel are determined from the measurements carried out with the microphones.

The present invention therefore relates to a model based active control system for a gas turbine, the associated mathematical model comprising a modular network in which calculated theoretical or analytical submodels are combined with specific experimental or empirical submodels in order to obtain an acoustic model of a gas turbine combustion system therefrom. The invention relates to a gas turbine combustion system in which use is made of an active control in order to modulate the fuel supply of the burners so as to suppress instabilities in combustion. The present invention relates in this case in particular to multi burner combustion systems.

Developments of the invention utilize experimental results that are obtained at a test facility having only one burner and one combustion chamber operating at ambient pressure, in conjunction with analytical methods in order to obtain an acoustic model of a multi burner combustion system that comprises a system for influencing the fuel feed. A closed loop controller or a control device can then be derived for the overall system on the basis of this acoustic model.

Developments of the invention can be used for the purpose of providing a control device for active control of instabilities in combustion. The control device is derived in this case from an acoustic network model that describes the acoustic properties of a combustion system. The advantage of a closed loop controller whose control algorithm is based on a mathematical model is to be seen in that the closed loop model can be tuned and optimized offline, that is to say independently of the operation of the gas turbine. For example, it is possible thereby to reduce or avoid cost intensive test runs for the gas turbine. Moreover, it is possible thereby to make use of better, more powerful control algorithms, for example by applying so called optimal control theory. In addition, the risk of damage to the gas turbine, for example owing to defective settings of the closed loop controller, can be reduced.

The method on which the present invention is based combines various acoustic modulation and measurement techniques in order to generate a modular network model that represents the dynamic acoustic area of a gas turbine. The advantage of such a method for determining a mathematical model of a gas turbine is to be seen in that it comprises measured responses of the gas turbine components without this requiring the need to carry out the respective measurements on an actual gas turbine.

Further important features and advantages of the invention follow from the drawings and from the associated description of the figures with the aid of the drawings.

### BRIEF DESCRIPTION OF THE DRAWINGS

Preferred exemplary embodiments of the invention are illustrated in the drawings and are explained in more detail in the following description, identical reference symbols relating to similar or functionally similar components. Schematically in each case,

FIG. 1 shows a simplified illustration of the principle of elements that are required for a control device of a single burner,

FIG. 2 shows a greatly simplified illustration of the principle of components that are required for a control device for a multi burner gas turbine,

FIG. 3 shows a simplified diagram that represents a number of submodels that represents in a burner a network of acoustic elements, in accordance with one embodiment of the present invention,

FIG. 4 shows a flowchart that represents in a simplified way steps participating in the determination of a model-based active closed loop controller for a gas turbine, in accordance with one embodiment of the present invention,

FIG. 5 shows a pressure profile against time for an H_{∞} controller that is derived by using one embodiment of the present invention,

FIG. 6 shows the profile of a spectral pressure amplitude with and without control for an H_{∞} controller that is derived by using the embodiment of the present invention,

FIG. 7 shows a greatly simplified illustration of the principle of a test facility, and

FIG. 8 shows a simplified block diagram of a modular network of an overall mathematical model.

### DETAILED DESCRIPTION OF EXEMPLARY EMBODIMENTS

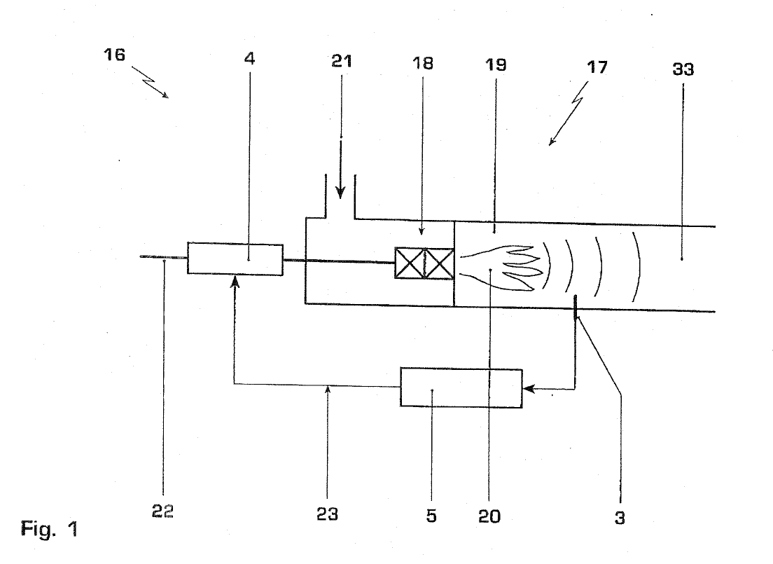

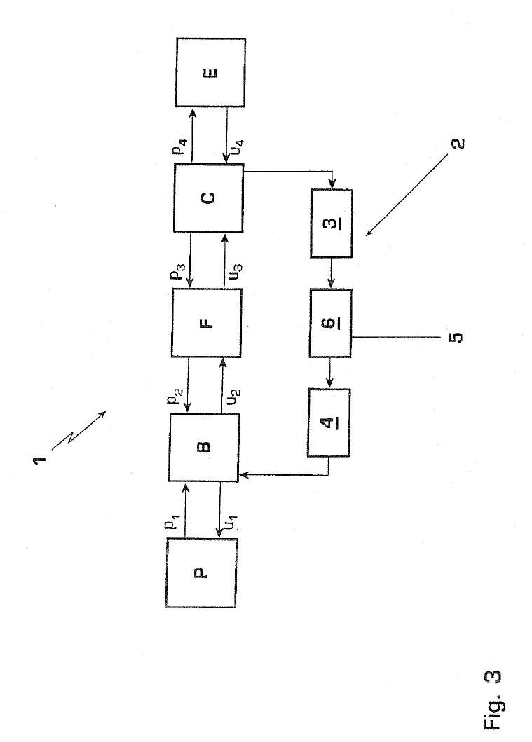

In accordance with FIG. 1, a test facility 16, which is configured according to the invention as a single burner ambient pressure gas turbine 17, includes only a single burner 18 that can produce a flame with a recirculation zone (not denoted in more detail) in a combustion chamber 19. The combustion chamber 19 operates in this case at atmospheric ambient pressure. The air required for the combustion reaction is fed here via an air supply 21, although without pressure worth mentioning. Pure suction of the combustion air is also possible in principle. Moreover, a fuel supply 22 is provided that feeds the fuel, preferably a gas, for example natural gas, required for the combustion process to the burner 18. Fuel supply 22 is assigned a fuel flow actuator 4 that can, for example, be configured as a linearly operating control valve. The test facility 16 is equipped with a control device 23 that includes a closed loop controller 5. Said closed loop controller 5 operates with the aid of a control algorithm (compare position 6 in FIG. 3) that is based on an overall mathematical model of the acoustic behavior of the combustion chamber 19 or of the overall combustion system. The closed loop controller 5 is connected on the input side to a pressure transducer 3 that detects pressure pulsations occurring in the combustion chamber 19 and transmits signals correlating therewith to the closed loop controller 5. The closed loop controller 5 is connected on the output side to the fuel flow actuator 4, as a result of which the closed loop controller 5 can actuate the fuel flow actuator 4 via appropriate control signals. The closed loop controller 5 can thereby vary or modulate the volume flow of the fuel fed to the burner 18.

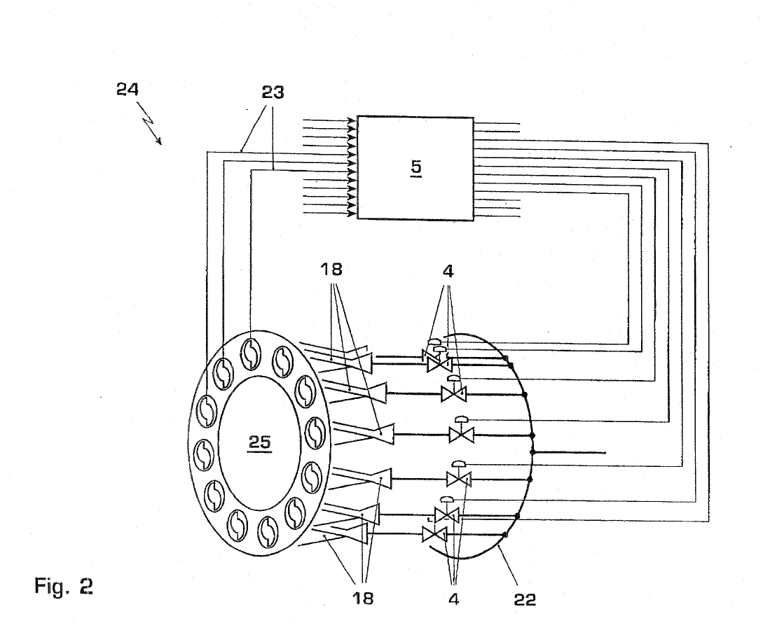

In accordance with FIG. 2, a conventional gas turbine 24 that is configured as a multi burner high pressure gas turbine includes a number of burners 18 that are arranged, for example, annularly. A common fuel supply 22 feeds the fuel to the burners 18. In this case, each individual burner 18 in the exemplary embodiment shown is assigned a dedicated fuel flow actuator 4, and so the fuel flow fed can be controlled individually for each burner 18.

The closed loop controller 5 can be connected on the input side to a number of pressure transducers (not shown), while being connected on the output side to the fuel flow actuators 4. The control device 23 formed with the aid of the closed loop controller 5 serves the purpose of controlling the pressure pulsations of a combustion process that runs in a combustion chamber 25, operated under high pressure, of the gas turbine 24. The control algorithm 6 of the closed loop controller 5 is then based on an overall mathematical model of the acoustic behavior of this combustion chamber 25.

In order to be able to derive or test a control algorithm, embodiments of the present invention provide a dynamic acoustic model of a combustion system that includes a combustion chamber 19, 25, at least one burner 18 and an actuator 4 for modulating a fuel supply 22. To this end, the overall combustion system including the actuator 4 is implemented as a modular network of acoustic components.

FIG. 3 shows by way of example a network of acoustic elements in accordance with one embodiment of the present invention. Each block in FIG. 3 represents a submodel or subsystem within the overall combustion system. The boundaries of the elements shown in FIG. 3 are defined such that they are represented by a submodel that is analytically calculated, or by a submodel that is experimentally determined.

In detail, the network shown in FIG. 3 and denoted by 1 includes as acoustic elements a plenum P, a burner B, a flame F, a combustion chamber C and a combustion chamber outlet E. The control device cooperating with the combustion system represented by the elements is represented here by a feedback loop 2 that includes a pressure transducer 3 cooperating with the combustion chamber C, a fuel flow actuator 4 assigned to the burner B, and a closed loop controller 5 with a control algorithm 6 stored therein.

The subsystems or submodels are characterized by their transfer matrices. Transfer matrices such as these relate the acoustic fields on the two sides (input and output) of the respective element to one another. The acoustic field is characterized in this case by two quantitative variables, on the one hand by the acoustic pressure (p), and on the other hand by the acoustic speed (u).

Consequently, the result for an acoustic element that relates the acoustic variables at two positions (u) and (d) to one another is a 2×2 transfer matrix T that relates the acoustic pressures and speeds at the two sides of the respective element to one another:

$$[ \begin{matrix}{p}_{d} \\ {u}_{d}\end{matrix} ] = [ \begin{matrix}{T}_{11} & {T}_{12} \\ {T}_{21} & {T}_{22}\end{matrix} ] [ \begin{matrix}{p}_{u} \\ {u}_{u}\end{matrix} ]$$

If more than two positions are in relation to one another, which can be the case, for example, with a multi burner configuration having a number N of burners, the relationship resulting therefrom can be represented by means of a 2N×2N matrix.

The burner element B and the flame element F in accordance with FIG. 3 are represented, for example, in each case by a 2N×2N transfer matrix. These matrices have a specific form. The respective matrix is configured as a block diagonal that has a number N of 2×2 matrices along its diagonal.

Assuming that all the burners of a multi burner gas turbine have the same properties, all these N diagonal matrices are identical. As a result of this property or assumption, all that is required is to determine the matrix representation of a single burner. The point is that in the case of N burners the associated matrix representation can easily be achieved by virtue of the fact that the matrix representation of the individual burner can be placed N times on the diagonal of the matrix of the multiburner arrangement. Consequently, a 2×2 transfer matrix that has been determined experimentally with the aid of a single burner installation can be used directly in an acoustic network of a multi burner system.

The experimental determination of the transfer matrices can be carried out as follows:

The respective element, for example a burner, is arranged in a test facility that includes or forms a test facility gas turbine. The test facility gas turbine has only a single test facility burner, and possesses a test facility combustion chamber that operates at atmospheric ambient pressure. The test facility includes, for example, a tube that serves as combustion chamber in the case of combustion. The test facility is equipped with an acoustic measuring apparatus such as, for example, microphones and suitable wires (hot wires), as well as with an apparatus for acoustic excitation such as, for example, a loudspeaker and a fuel flow actuator.

Excitation signals are introduced into the system for the respective test operation with the aid of the apparatus for acoustic excitation. The relevant acoustic variables such as, for example, acoustic pressure and acoustic speed can then be measured with the aid of the acoustic measuring apparatus. These measurements are repeated, for example, for various different frequencies. Different test phases can thereby be delimited from one another such that the excitation signals are introduced sequentially upstream or downstream of the respective element with the aid of the equipment for acoustic excitation.

Alternatively, different test phases can be achieved by varying the geometry of the entrance or the exit of the tube. Two different test phases are required in order to determine the associated transfer matrix. The various test phases are identified by superscript letters (A) and (B).

The associated transfer matrix is then yielded as follows:

$$[ \begin{matrix}{p}_{d}^{A} & {p}_{d}^{B} \\ {u}_{d}^{A} & {u}_{d}^{B}\end{matrix} ] = [ \begin{matrix}{T}_{11} & {T}_{12} \\ {T}_{21} & {T}_{22}\end{matrix} ] [ \begin{matrix}{p}_{u}^{A} & {p}_{u}^{B} \\ {u}_{u}^{A} & {u}_{u}^{B}\end{matrix} ] ⇒ [ \begin{matrix}{T}_{11} & {T}_{12} \\ {T}_{21} & {T}_{22}\end{matrix} ] = {[ \begin{matrix}{p}_{u}^{A} & {p}_{u}^{B} \\ {u}_{u}^{A} & {u}_{u}^{B}\end{matrix} ]}^{- 1} [ \begin{matrix}{p}_{d}^{A} & {p}_{d}^{B} \\ {u}_{d}^{A} & {u}_{d}^{B}\end{matrix} ]$$

It may be stated that the selection of the boundaries of these elements is fundamentally arbitrary. However, the boundaries selected in FIG. 3 can be represented by a submodel that can be calculated analytically, or by a submodel that can be determined experimentally.

The wave propagation in the combustion chamber can usually be represented by the use of an analytical submodel. This is to be ascribed to the fact that the purely acoustic wave propagation is comparatively easy to modulate. Nevertheless, it is comparatively difficult to carry out acoustic measurements in an actual combustion system. In the case of a gas turbine, this is to be ascribed to the high temperatures, pressures and restricted access possibilities there.

In any case, the complex interactions of a burner and the combustion process can be simulated, only with relative difficulty using an analytical model, and so experimental measurements are required. The response or reaction of the fuel flow actuator is likewise very difficult to model, and so it is also necessary for this element to be determined experimentally. The experiments required to this end are carried out on a test facility that is configured as a single burner ambient pressure test facility gas turbine. The gas turbine is equipped with loudspeakers and microphones in order, on the one hand, to be able to excite the system and, on the other hand to be able to measure the response of the system. The experimental measured values or input data are determined by measuring acoustic transfer functions or acoustic transfer matrices. The matrices then enable the complete description of the relationship between two acoustic variables within or through the respective element.

For example, the response of the fuel flow actuator is determined by virtue of the fact that appropriate signals are transmitted to the actuator, and that its reaction of response to the combustion process is measured with the aid of the transfer function measuring technique.

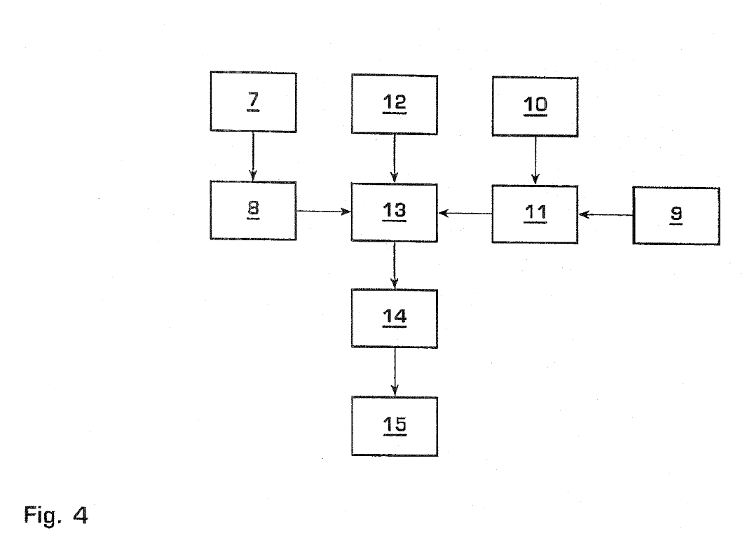

A flowchart of the steps that participate during the determination of a model-based active closed loop controller for a gas turbine are reproduced in FIG. 4. Here, the individual steps are symbolized by blocks. Block 7 represents the measurements of the transfer matrices with the aid of the single burner ambient pressure test facility gas turbine. Block 8 represents the determination of the transfer matrices for the individual elements. Block 9 represents an analytical submodel. Block 10 represents the numerical modeling of an acoustic model of the gas turbine geometry. Block 11 represents the generation of transfer matrices for individual elements. Block 12 transcribes the identification and definition of the problem of thermal acoustic pulsations for gas turbines. The central element here is block 13, which represents a thermal-acoustic dynamic network model of the gas turbine, including the fuel flow actuator. This is, as it were, the overall model of the control algorithm, which is produced with the aid of the inventive method and assembled by a network of analytical and empirical submodels. In a subsequent step in accordance with block 14, the closed loop controller is derived with the aid of the control algorithm by means of synthesis methods and simulation methods. The closed loop controller found is subsequently implemented in the respective gas turbine and tested in block 15.

Consequently, the actual control algorithm can be derived as soon as all the relevant data have been determined by the previously described combination of experimental and analytical measures.

Any suitable synthesis technique can be used in principle to derive a closed loop controller if the relevant data are present. For example, an H_{∞} controller can be used. In this example, the closed loop controller has been determined with the aid of the test facility using the previously described mode of procedure. Subsequently, it is implemented in the test facility gas turbine and tested with the latter in the test facility. The goal of the closed loop controller is to stabilize the combustion system and minimize effects of disturbances that are produced by various sources within the system.

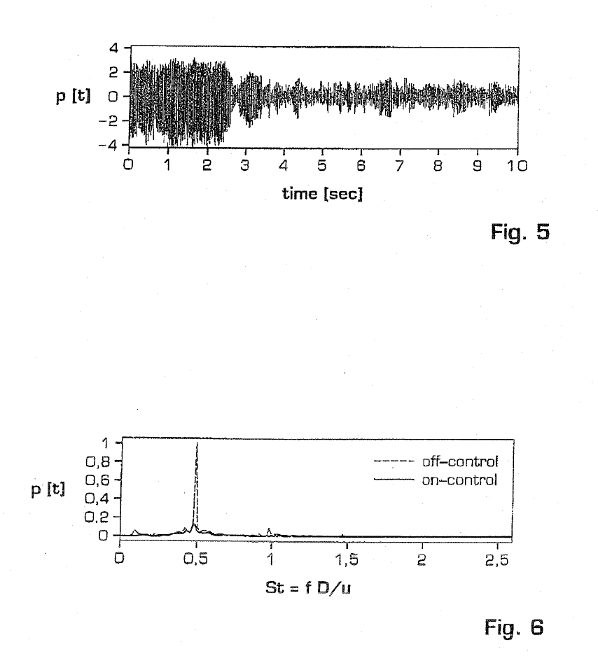

The fuel flow activator has a limited input range. Consequently, the control signal transmitted by the closed loop controller to the actuator should remain within predetermined limits. Experimental results show that a closed loop controller that fulfills these controller goals can be achieved by a so called H_{∞} optimization. The closed loop controller determined in this way can then be applied in a single burner ambient pressure test facility gas turbine. In accordance with FIG. 5, tests have shown that pulsation amplitudes can be reduced by more than 25 dB.

FIG. 6 shows the profile of a spectral pressure amplitude with or without control for an H_{∞} controller that has been derived with the aid of one embodiment of the present invention.

It may be stated that a control method which demonstrably operates satisfactorily in a single burner ambient pressure test facility gas turbine cannot be applied in a multi burner high pressure gas turbine. In order to be able to apply the closed loop controller thus determined in an actual gas turbine, it is necessary to carry out the abovedescribed transformation from the single burner ambient pressure test facility gas turbine into the respective multi burner high pressure gas turbine.

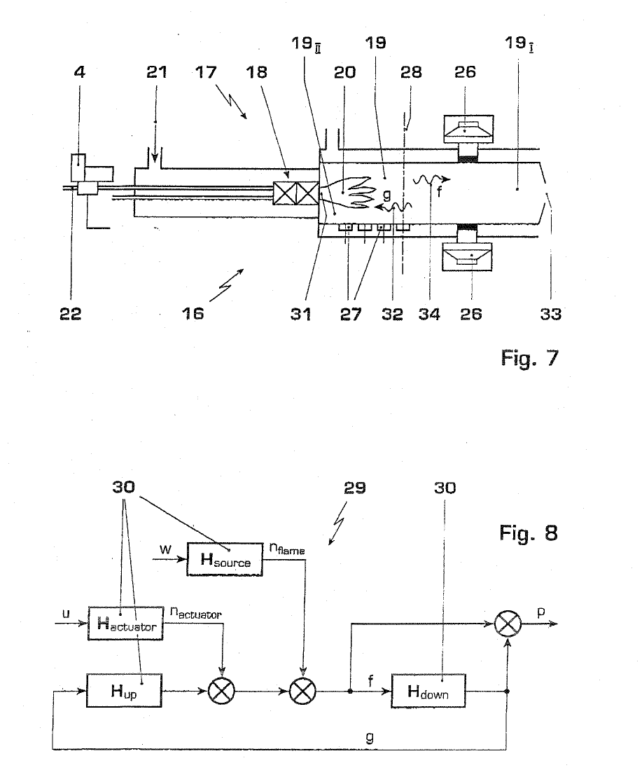

In accordance with FIG. 7, the test facility 16 already shown in FIG. 1 can additionally be fitted with loudspeakers 26 that are, for example, cooled with liquid. The overall system of the test facility 16 can be excited by means of an acoustic signal with the aid of the loudspeakers 26. The loudspeakers 26 are arranged on the combustion chamber 19 in this case. Likewise arranged on the combustion chamber 19 are a number of microphones 27 positioned one behind another in the flow direction. The microphones 27 serve the purpose of measuring the reaction or the response of the system to the excitation produced with the aid of the loudspeakers 16.

Shown, moreover, with a dotted line in FIG. 7 is a reference position 28 that separates in virtual terms inside the combustion chamber 19 a region 19_{I} lying downstream from a region 19_{II} of the combustion chamber 19 lying upstream. It is to be remarked that the arrangement of the microphones 27 begins at the reference position 28 and extends therefrom in the counterflow direction, that is to say into the region 19_{II} of the combustion chamber 19 lying upstream.

In a greatly simplified fashion, FIG. 8 shows the abovenamed overall mathematical model, denoted by 29 here, for describing the acoustic behavior of the combustion system. This overall mathematical model 29 is subdivided here empirically into four submodels 30, specifically according to the invention into at least one analytical submodel and into at least one empirical submodel, something which will be explained in yet more detail below. In the case of the exemplary embodiment shown here, three empirical submodels and one analytical submodel are provided. The empirical submodels can be determined by means of experimental measurements, something which has already been explained above in detail. In contrast thereto, the analytical submodels can be calculated by means of physical relationships.

A first empirical submodel is denoted by Hᵤₚ in the present example. The first empirical submodel Hᵤₚ describes the dynamic processes running in the test facility combustion chamber 19 upstream of the reference position 28. These dynamic processes comprise, for example, the wave propagation from the reference position 28 up to a burner outlet 31, and the acoustic properties of the combustion process of the burner 18 and of a plenum chamber (not denoted here in more detail) of the combustion chamber 19. A wave moving from the reference position 28 in the direction of the burner outlet 31 is denoted by 32 in FIG. 7.

A second empirical submodel is denoted here by H_{down}, and describes the dynamic processes running downstream of the reference position 28 in the test facility combustion chamber 19. The dynamic processes running in the region 19_{I} of the combustion chamber 19 lying downstream again comprise the wave propagation from the reference position 28 up to an outlet 33 of the combustion chamber 19. Reflection effects at the combustion chamber outlet 33 are likewise taken into account.

A third empirical model is denoted here by H_{actuator} and describes the dynamic processes of a control device for setting a fuel quantity fed to the burners 18, as well as the influence thereof on the combustion process. Said control device is the fuel flow actuator 4 here. The third empirical submodel H_{actuator} further takes account of the wave propagation from the flame 20 up to the reference position 28. The wave propagation in the flow direction is symbolized in FIG. 7 by an arrow 34.

In the present case, only one analytical submodel is provided, being denoted by H_{source}. This analytical model H_{source} describes the acoustic interference source of the combustion process, which is defined as a rule by the turbulence of the flame 20.

It is presupposed or assumed for the purpose of determining the empirical submodels, that is to say for the identification of the empirical submodels, that all the submodels 30 are stable, and that possible instabilities are caused exclusively by the feedback loop 2 of the control device 23. It is possible thereby to identify an overall model or overall system for which it is unknown whether it is asymptotically stable or not.

The approach for identifying the individual empirical submodels is a stepwise one to the effect that each empirical submodel is identified separately. It is noteworthy in this case that at least one of the other submodels 30 is modified or varied during the identification of an empirical submodel. For example, geometric boundary conditions and/or operational parameters can be varied in one or other submodel 30. It is important that the submodel currently to be determined or to be identified is not varied in this case. Said variations are executed such that the overall system exhibits only very small pulsation amplitudes with ensure that the overall system has an asymptotic stability.

If, for example, the aim is to identify the second empirical submodel H_{down}, the output variable of the first empirical submodel Hᵤₚ is temporarily reduced in order to ensure comparatively small pulsation amplitudes. In the reverse case, the output value of the second empirical submodel H_{down} is reduced during the identification of the first empirical submodel Hᵤₚ. The identified submodels 30 can be combined in or to form a feedback system that represents an overall system which is linearized in the region of its nominal operating point. Such a model does not comprise nonlinear dynamic effects of the system, but this is not a problem since a closed loop controller that can stabilize a linearized system can readily also stabilize a nonlinear system.

The proposed examination of the combustion chamber 19 of the test facility 16 is based chiefly on acoustic properties of the combustion chamber 19 or the gas turbine 17 fitted therewith. The system is excited by an excitation signal in each identification step. Excitation signals can be provided, for example, with the aid of the loudspeakers 26, of the fuel flow actuator 4, and via the noise development of the flame 20. The response or reaction of the system is measured with the aid of the array of microphones 27. The acoustic field of the system can be expressed as the sum of two waves that propagate in opposite directions. The acoustic wave 32 traveling upstream and the acoustic wave 34 traveling downstream are correlated with the Riemann constants f and g, and are extracted from the pressure signals, something which is possible with the aid of the microphone array. The Riemann constants f and g can be used in determining and/or calculating submodels.

For example, the four submodels 30 shown in FIG. 8 can be determined or calculated as follows:

In order to determine the first empirical submodel Hᵤₚ, the overall system can be excited with the aid of the loudspeakers 26. Subsequently, a frequency response of the first empirical submodel Hᵤₚ is measured with the aid of the microphones 27. Subsequently, a cross correlation between the frequency response and the excitation of the overall model can be determined. Moreover, the Riemann constants f and g can be calculated from the measurements: see above. Finally, a ratio of the Riemann constants can optionally be calculated, and this finally represents the transfer function of the first empirical submodel: Hᵤₚ=f/g.

The second empirical submodel H_{down} is fundamentally determined in a similar way as for the first empirical submodel Hᵤₚ. However, the excitation of the overall model in the case of the second empirical submodel is produced with the aid of the fuel flow actuator 4, which is driven in a suitable way to this end. Here, as well, the frequency response of the second empirical submodel H_{down} is preferably measured by means of the microphones 27. It is likewise possible here, moreover, to determine a cross correlation between the frequency response and the excitation of the overall model.

In order to determine the third empirical model H_{actuator}, the overall model can be excited by transmitting appropriate actuating signals u to the control device, that is to say to the fuel flow actuator 4. This corresponds fundamentally to the previously described mode of procedure for identifying the second empirical submodel H_{down}. However, the actuating signals u are now here of greater importance. Here, as well, the frequency response of the third empirical submodel H_{actuator} is measured. Moreover, the cross correlation can be determined between the frequency response and the excitation of the overall model, the Riemann constants f and g being taken into account together with the actuation signal u. The transfer functions for the third empirical submodel is yielded here as follows: H_{actuator}=(f−g*Hᵤₚ)/u.

The analytical submodel H_{source} or its transfer function can be calculated as follows: H_{source}=(f−g*Hᵤₚ). A noise signal (white noise) is assumed for the input signal of the transfer function of the analytical submodel H_{source}.

During the measurement of the second empirical submodel H_{down}, the output signal of the first empirical submodel Hᵤₚ is varied in such a way as to select operating conditions or operating parameters for which an operating behavior of the overall system with low pulsation amplitudes is expected. During the measurement of the first empirical submodel Hᵤₚ, the output signals of the second empirical submodel H_{down}, can be varied by virtue of the fact that a throttle plate is mounted at the outlet 33 of the combustion chamber 19.

After all the subsystems or submodels 30 have been identified or determined and calculated, the overall system or the overall model can be joined up to form an acoustic network 29 that is reproduced in FIG. 8. In order to be able to derive dynamic models from the experimentally obtained data, rational polynomials in equations of the Laplace coefficients are integrated in the frequency responses of the individual submodels 30.

### LIST OF REFERENCE NUMERAL SYMBOLS

1 Overall model

2 Feedback loop

3 Pressure transducer

4 Fuel flow actuator

5 Closed loop controller

6 Control algorithm

7 to 15 Block/step

16 Test facility

17 Single burner ambient pressure test facility gas turbine

18 Burner

19 Combustion chamber

20 Flame

21 Fresh air supply

22 Fuel supply

23 Control device

24 Gas turbine

25 Combustion chamber

26 Loudspeaker

27 Microphone

28 Reference position

29 Mathematical model

30 Submodel

31 Outlet of 18

32 Sound wave

33 Outlet of 19

34 Sound wave

Hᵤₚ First empirical submodel

H_{down} Second empirical submodel

H_{actuator} Third empirical submodel

H_{source} Analytical submodel

P Plenum

B Burner

F Flame

C Combustion chamber

E Outlet of C

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents.

1. A method for producing a control device for controlling pressure pulsations in a combustion process that is running in a combustion chamber, operated at high pressure, of a gas turbine operating with a number of burners, a closed loop controller of the control device operating with the aid of a control algorithm that is based on an overall mathematical model of the acoustic behavior of the combustion system, the method comprising:
subdividing the overall model into a number of submodels of which at least one is configured as an analytical submodel that can be calculated by physical relationships, and at least one submodel is configured as an empirical submodel that can be determined by experimental measurements;
determining the at least one empirical submodel by carrying out experimental measurement on a test facility a test facility gas turbine of which has only a single test facility burner and a test facility combustion chamber operating at atmospheric ambient pressure;
calculating the at least one analytical submodel by taking into account the results of the experimental measurements in order to determine the at least one empirical submodel; and
networking the determined and calculated submodels at least with computational transformation of the single burner ambient pressure test facility gas turbine to form the multi burner high-pressure gas turbine.

2. The method as claimed in claim 1, comprising:
deriving the closed loop controller from the networked submodels.

3. The method as claimed in claim 1, further comprising:
representing interactions of at least one burner and the combustion chamber by an empirical submodel; or
representing reactions of a control device for setting a fuel quantity fed to at least one burner by an empirical submodel; or
representing dynamic processes that run in the counterflow direction inside the test facility combustion chamber from a reference position up to the exit of the test facility burner by an empirical submodel; or
representing dynamic processes that run in the flow direction inside the test facility combustion chamber from a reference position up to the exit of the test facility combustion chamber by an empirical submodel; or
representing the propagation of the pressure waves in the combustion chamber by an analytical submodel; or combinations thereof.

4. The method as claimed in claim 1, wherein:
determining an empirical submodel comprises varying at least one other submodel with regard to geometry, operating conditions, or both, while the empirical submodel to be determined is not varied; or
varying said at least one other submodel with regard to geometry, operating conditions, or both, so that the overall model is asymptotically stable, has relatively small or uncritical pulsation amplitudes, or both; or both.

5. The method as claimed in claim 1, wherein:
determining the at least one empirical submodel comprises using at least one loudspeaker to introduce pressure pulses of a specific frequency at a reference position into the test facility combustion chamber downstream of the test facility burner; or
determining the at least one empirical submodel comprises modulating the pressure of an air supply of the test facility burner, fuel feed of the test facility burner, or both; or
determining the at least one empirical submodel comprises measuring a reaction of the overall model with a number of microphones arranged next to one another in the flow direction arranged between the reference position and the exit of the test facility burner; or
determining the at least one empirical submodel comprises determining Riemann constants (f) and (g) that are used during the determination of an empirical submodel, during the calculation of an analytical submodel, or both, from the measurements carried out with said microphones; or combinations thereof.

6. The method as claimed in claim 1, further comprising:
determining an empirical submodel (Hᵤₚ) that describes the dynamic processes running upstream of a reference position in the test facility combustion chamber, including
exciting the overall model by at least one loudspeaker,
measuring a frequency response of the empirical submodel (Hᵤₚ),
determining a cross correlation between the frequency response and the excitation of the overall model,
calculating the Riemann constants (f) and (g), and
calculating a ratio of the Riemann constants (f) to (g).

7. The method as claimed in claim 1, further comprising:
determining an empirical submodel (H_{down}) that describes the dynamic processes running downstream of a reference position in the test facility combustion chamber, including
exciting the overall model with a corresponding actuation of a control device for setting a fuel quantity fed to the test facility burner,
measuring a frequency response of the empirical submodel (H_{down}), and
determining a cross correlation between the frequency response and the excitation of the overall model.

8. The method as claimed in claim 1, further comprising:
determining a an empirical submodel (H_{actuator}) that describes the dynamic operations of a control device for setting a fuel quantity fed to the burner and the influence of the fuel quantity fed to the burner on the combustion process, including
exciting the overall model with actuation signals (u) sent to the control device,
measuring a frequency response of the empirical submodel (H_{actuator}), and
determining a cross correlation between the frequency response and the excitation of the overall model by taking into account Riemann constants (f) and (g) and the actuation signal (u).

9. The method as claimed in claim 6, further comprising:
calculating an analytical submodel (H_{source}) that describes acoustic interference sources of the combustion process from the Riemann constants (f) and (g) and from the cross correlation of the empirical submodel (Hᵤₚ).

10. The method as claimed in claim 6,
wherein the empirical submodel is a first empirical submodel, and:
further comprising determining a second empirical submodel (H_{down}) that describes the dynamic processes running downstream of a reference position in the test facility combustion chamber, including
exciting the overall model with a corresponding actuation of a control device for setting a fuel quantity fed to the test facility burner,
measuring a frequency response of the second empirical submodel (H_{down}), and
determining a cross correlation between the frequency response and the excitation of the overall model, and
varying the first empirical submodel (Hᵤₚ) setting an operating state for the first empirical submodel that reliably has low or uncritical pressure pulsation amplitudes; or
wherein determining the first empirical submodel (Hᵤₚ) comprises varying the second empirical submodel (H_{down}) arranging a throttle plate at the exit of the combustion chamber; or both.
